(19) United States
(12) Patent Application Publication
(10) Pub. No.: US 2026/0367270 A1
(43) Pub. Date: Nov. 19, 2026

(54) Conditioning Seismic First Breaks

(71) Applicant: Saudi Arabian Oil Company, Dhahran (SA)

(72) Inventors: Lu Liu, Beijing (CN); Mohammed S. Mubarak, Safwa (SA); Young Seo Kim, Dhahran (SA); Yue Ma, Beijing (CN); Constantinos Tsingas, Dhahran (SA)

(21) Appl. No.: 19/212,007

(22) Filed: May 19, 2025

(51) Int. Cl. G01V 1/34; G01V 1/30

(52) U.S. Cl. CPC G01V 1/345; G01V 1/301; G01V 1/303; G01V 2210/642

(57) ABSTRACT

Systems and methods for enhancing a signal-to-noise ratio in a near surface seismic survey of a subsurface formation include obtaining seismic data from a near surface seismic survey; determining diving wave travel-time parameters for the seismic data based on diving wave energy; and isolating early arrivals data in the seismic data based on the travel-time parameters. The isolated early arrivals data are transformed from a time-offset domain to an intercept-time-slowness-parameter domain using a Radon transform; a sparse Radon transform model of the transformed isolated early arrivals data is generated. Artifacts in the sparse Radon transform model are suppressed by applying a weight in the intercept-time-slowness-parameter domain. The weighted, sparse Radon transform model is transformed to the time-offset domain using an inverse Radon transform to generate denoised early arrivals data. A seismic image of the subsurface formation is generated based on the denoised early arrivals data.

### TECHNICAL FIELD

This disclosure generally relates to geological exploration of a subsurface formation based on, for example, conditioning seismic first breaks.

### BACKGROUND

In geology, sedimentary facies are bodies of sediment that are recognizably distinct from adjacent sediments that resulted from different depositional environments. Generally, geologists distinguish facies by aspects of the rock or sediment being studied. Seismic facies are groups of seismic reflections whose parameters (such as amplitude, continuity, reflection geometry, and frequency) differ from those of adjacent groups. Seismic facies analysis, a subdivision of seismic stratigraphy, plays an important role in hydrocarbon exploration and is one key step in the interpretation of seismic data for reservoir characterization. The seismic facies in a given geological area can provide useful information, particularly about the types of sedimentary deposits and the anticipated lithology.

In reflection seismology, geologists and geophysicists perform seismic surveys to map and interpret sedimentary facies and other geologic features for applications such as, for example, identification pf potential petroleum reservoirs. Seismic surveys are conducted by using a controlled seismic source (for example, Vibroseis or dynamite) to create a seismic wave. The seismic source is typically located at ground surface. The seismic wave travels into the ground, is reflected by subsurface formations, and returns to the surface where it is recorded by sensors called geophones. The geologists and geophysicists analyze the time it takes for the seismic waves to reflect off subsurface formations and return to the surface to map sedimentary facies and other geologic features. This analysis can also incorporate data from sources such as, for example, borehole logging, gravity surveys, and magnetic surveys.

One approach to this analysis is based on tracing and correlating along continuous reflectors throughout the dataset produced by the seismic survey to produce structural maps that reflect the spatial variation in depth of certain facies. These maps can be used to identify impermeable layers and faults that can trap hydrocarbons such as oil and gas.

### SUMMARY

The accuracy of structural maps generated based on seismic survey data can be improved by correcting for variations in the data caused by differences in surface elevation, variations due to low velocity near surface layers, or other irregularities. Determining static corrections and near-surface velocity estimations includes picking first-breaks in the seismic data. First-breaks indicate the onset of the first signal arrivals at geophones. In general, these arrivals are associated with the energy of refracted waves at the base of a weathering layer or a direct wave that travels directly from the seismic source to the receiver (e.g., geophone). The quality of first-breaks is related to the near-surface structure, the seismic source type, and the signal-to-noise ratio conditions.

This disclosure provides an approach for conditioning first breaks in seismic survey data by increasing the signal-to-noise (S/N) ratio of the seismic data and suppressing artifacts in the data. This approach can condition first breaks in seismic data prior to first break picking by using a scanning-based early arrivals isolation (SEAI) and a weighted, sparse Radon transform. SEAI can use offset-dimension information in the seismic data to isolate a reasonable processing zone in the seismic data based on, for example, stacking diving wave energy prior to first breaks picking. The weighted, sparse Radon transform can be used on the isolated data to increase the signal-to-noise ratio and suppress artifacts. The sparse Radon transform operator can be determined in a least-squares sense and noise in the seismic data can be further suppressed through an iterative soft thresholding technique. To further improve the coherent signal and suppress the noise and other undesired artifacts, a weighting function can be applied to the seismic data sparse Radon transformed data.

This disclosure describes systems and methods for enhancing a signal-to-noise ratio in near surface seismic data from a seismic survey of a subsurface formation. The described systems and methods can utilize a data processing system (e.g., a computer or control system). The data processing system can obtain seismic data from a near surface seismic survey with the seismic data representing a subsurface formation. The data processing system can determine diving wave travel-time parameters for the seismic data based on diving wave energy. The data processing system can isolate early arrivals data in the seismic data based on the travel-time parameters. The early arrivals data represents first seismic waves to reach a seismic receiver after being generated by a seismic source. The data processing system can transform the isolated early arrivals data from a time-offset domain to an intercept time-slowness parameter domain using a Radon transform. The data processing system can generate a sparse Radon transform model of the transformed isolated early arrivals data using an iterative soft thresholding technique. The data processing system can suppress artifacts in the sparse Radon transform model by applying a weight to the sparse Radon transform model in the intercept time-slowness parameter domain. The data processing system can generate denoised early arrivals data by transforming the weighted, sparse Radon transform model to the time-offset domain using an inverse Radon transform. The data processing system can generate a seismic image of the subsurface formation based on the denoised early arrivals data.

Implementations of the systems and methods of this disclosure can provide various technical benefits. For example, the described systems and methods improve the data quality of diving and postcritical early arrivals to facilitate subsequent first breaks picking by increasing the S/N ratio and suppressing artifacts for the diving and postcritical early arrivals. These systems and methods can attenuate interference caused by undesired coherent events, such as converted waves from events with undesired moveouts. These systems and methods provide improved seismic data for first breaks picking and near-surface model building. These systems and methods enable automated picking of first breaks for seismic data acquired in complex near-surface geologies and/or in seismic data with a low S/N ratio. These systems and methods can improve first breaks picking resulting in more reliable near-surface velocity models and improved subsurface seismic imaging and reservoir delineation as compared with conventional methods or unconditioned first breaks. The systems and methods of this disclosure can be used in applications such as near-surface tomographic static corrections that require precise and rapid automated detection of the signal first arrivals.

The described systems and method can remove artifacts and noise that reduce local minima in the seismic data resulting in faster convergence of subsequent seismic data inversion processing, such as full waveform inversion (FWI) or first-arrival travel-time tomography For example, the described systems and methods can remove linear artifacts (e.g., blended signals) from early arrivals before inversion to reduce creation of false structures in a FWI tomogram. The described systems and methods can provide an initial velocity model from the SEAI, which can quickly provide an initial understanding of the subsurface velocities. These systems and methods can also improve the low-frequency components of the early arrivals by, for example, filtering out high frequency content during transformation of the data to the time-offset domain. Improved low-frequency components can be used to generate near surface velocity models that reveal complex geological features.

The details of one or more implementations of these systems and methods are set forth in the accompanying drawings and the description below. Other features, objects, and advantages of these systems and methods will be apparent from the description and drawings, and from the claims.

### DESCRIPTION OF DRAWINGS

FIG. 1 is a schematic view of a seismic survey being performed to map subsurface features such as facies and faults.

FIGS. 2A, 2B, and 2C schematically illustrate the process of stacking a group of seismic traces to improve the signal to noise ratio of the traces.

FIG. 3 is a flow chart for an example method for enhancing the S/N ratio of near-surface seismic data from a seismic survey.

FIGS. 4A and 4B illustrate a common shot gather from a seismic receiver line and isolated early arrivals from the common shot gather.

FIG. 5 illustrates noise suppression and artifact removal from the common shot gather in FIG. 4A using a weighted, sparse Radon transform.

FIGS. 6A and 6B are partial seismic data from a three-dimensional (3D) shot gather.

FIGS. 7A and 7B are the isolated early arrivals from the seismic data in FIGS. 6A and 6B.

FIGS. 8A and 8B are enhanced seismic data from applying a sparse Radon transform to the isolated early arrivals in FIGS. 7A and 7B.

FIGS. 9A and 9B illustrate the noise removed from the isolated early arrivals in FIGS. 7A and 7B relative to the enhanced seismic data in FIGS. 8A and 8B.

FIGS. 10A and 10B are further enhanced seismic data with improved coherency from applying a weighted, sparse Radon transform to the isolated early arrivals of FIGS. 7A and 7B.

FIGS. 11A, 11B, 11C, and 11D illustrate seismic data at stages of processing to enhance the signal to noise ratio of the seismic data.

FIG. 12 is a tomogram showing FWI data generated using enhanced signal to noise ratio seismic data.

FIG. 13 illustrates hydrocarbon production operations that include field operations and computational operations, according to some implementations.

FIG. 14 is a block diagram illustrating an example computer system used to provide computational functionalities associated with described algorithms, methods, functions, processes, flows, and procedures according to some implementations of the present disclosure.

Like reference symbols in the various drawings indicate like elements.

### DETAILED DESCRIPTION

This disclosure provides an approach for conditioning first breaks in seismic survey data by increasing the signal-to-noise (S/N) ratio of the seismic data and suppressing artifacts in the data. This approach can condition first breaks in seismic data prior to first break picking by using a SEAI and a weighted, sparse Radon transform. SEAI can use offset-dimension information in the seismic data to isolate a reasonable processing zone in the seismic data based on, for example, stacking diving wave energy prior to first breaks picking. The weighted, sparse Radon transform can be used on the isolated data to increase the signal-to-noise ratio and suppress artifacts. The sparse Radon transform operator can be determined in a least-squares sense and noise in the seismic data can be further suppressed through an iterative soft thresholding technique. To further improve the coherent signal and suppress the noise and other undesired artifacts, a weighting function can be applied to the seismic data sparse Radon transformed data.

This disclosure describes systems and methods for enhancing a signal-to-noise ratio in near surface seismic data from a seismic survey of a subsurface formation. The described systems and methods can utilize a data processing system (e.g., a computer or control system). The data processing system can obtain seismic data from a near surface seismic survey with the seismic data representing a subsurface formation. The data processing system can determine diving wave travel-time parameters for the seismic data based on diving wave energy. The data processing system can isolate early arrivals data in the seismic data based on the travel-time parameters. The early arrivals data represents first seismic waves to reach a seismic receiver after being generated by a seismic source. The data processing system can transform the isolated early arrivals data from a time-offset domain to an intercept time-slowness parameter domain using a Radon transform. The data processing system can generate a sparse Radon transform model of the transformed isolated early arrivals data using an iterative soft thresholding technique. The data processing system can suppress artifacts in the sparse Radon transform model by applying a weight to the sparse Radon transform model in the intercept time-slowness parameter domain. The data processing system can generate denoised early arrivals data by transforming the weighted, sparse Radon transform model to the time-offset domain using an inverse Radon transform. The data processing system can generate a seismic image of the subsurface formation based on the denoised early arrivals data.

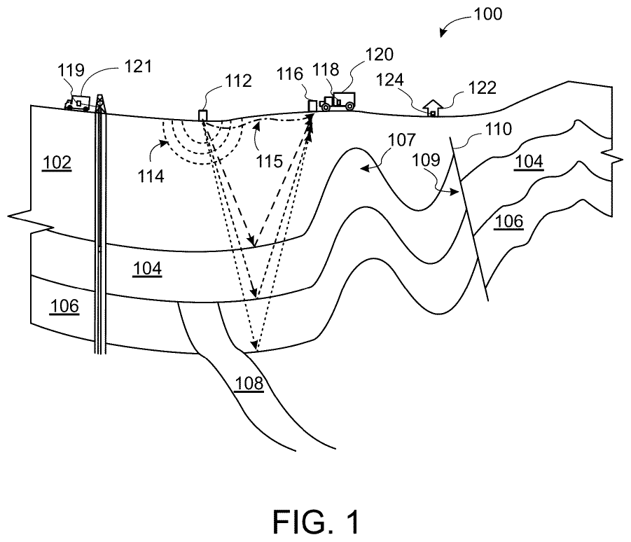

FIG. 1 is a schematic view of a seismic survey being performed to map subsurface features such as facies and faults in a subsurface formation 100. The subsurface formation 100 includes a layer of impermeable cap rocks 102 at the surface. Facies underlying the impermeable cap rocks 102 include a sandstone layer 104, a limestone layer 106, and a sand layer 108. A fault line 110 extends across the sandstone layer 104 and the limestone layer 106.

A seismic source 112 (for example, a seismic vibrator or an explosion) generates seismic waves 114 that propagate in the earth. The velocity of these seismic waves depends on properties such as, for example, density, porosity, and fluid content of the medium through which the seismic waves are traveling. Different geologic bodies or layers in the earth are distinguishable because the layers have different properties and, thus, different characteristic seismic velocities. For example, in the subsurface formation 100, the velocity of seismic waves traveling through the subsurface formation 100 will be different in the sandstone layer 104, the limestone layer 106, and the sand layer 108. As the seismic waves 114 contact interfaces between geologic bodies or layers that have different velocities, the interface reflects some of the energy of the seismic wave and refracts part of the energy of the seismic wave. Such interfaces are sometimes referred to as horizons.

The seismic waves 114 are received by a sensor or sensors 116. Although illustrated as a single component in FIG. 1, the sensor or sensors 116 are typically a line or an array of sensors 116 that generate an output signal in response to received seismic waves including waves reflected by the horizons in the subsurface formation 100. The sensors 116 can be geophone-receivers that produce electrical output signals transmitted as input data, for example, to a computer 118 on a seismic control truck 120. Based on the input data, the computer 118 may generate a seismic data output such as, for example, a seismic two-way response time plot.

A control center 122 can be operatively coupled to the seismic control truck 120 and other data acquisition and wellsite systems. The control center 122 may have computer facilities for receiving, storing, processing, and/or analyzing data from the seismic control truck 120 and other data acquisition and wellsite systems. For example, computer systems 124 in the control center 122 can be configured to analyze, model, control, optimize, or perform management tasks of field operations associated with development and production of resources such as oil and gas from the subsurface formation 100. Alternatively, the computer systems 124 can be located in a different location than the control center 122. Some computer systems are provided with functionality for manipulating and analyzing the data, such as performing seismic interpretation or borehole resistivity image log interpretation to identify geological surfaces in the subsurface formation or performing simulation, planning, and optimization of production operations of the wellsite systems.

In some implementations, results generated by the computer system 124 may be displayed for user viewing using local or remote monitors or other display units. One approach to analyzing seismic data is to associate the data with portions of a seismic cube representing represent the subsurface formation 100. The seismic cube can also be display results of the analysis of the seismic data associated with the seismic survey.

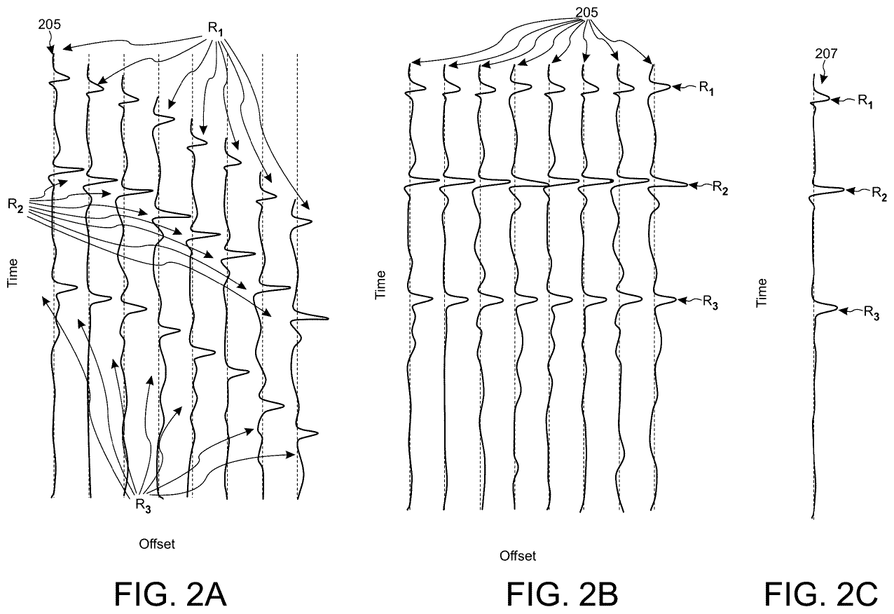

FIGS. 2A, 2B, and 2C schematically illustrate the process stacking a group of seismic traces 205 to improve the signal to noise ratio of the traces. FIG. 2A illustrates a common midpoint (CMP) gather of eight traces 205 generated by a set of sources and sensors that share a common midpoint. For ease of explanation, the traces are assumed to have been generated by reflections from three horizontal horizons.

The traces 205 are arranged with increasing offset from the CMP. The offset of the traces 205 from the CMP increase from left to right and the reflection time increases from top to bottom. Increasing offset from the common midpoint increases the angle of a seismic wave that between a source and a sensor, increases the distance the wave travels between the source and the sensor, and increases the slant reflection time. The increasing time for the reflections (R₁, R₂, R₃) from each of the horizons to arrive for source-sensor pairs with increasing offsets from the CMP reflects this increased slant time.

FIG. 2B shows the traces 205 after normal moveout (NMO) correction. NMO is the difference between vertical reflection time and the slant reflection time for a given source-sensor pair. This correction places reflections (R₁, R₂, R₃) from common horizons at the same arrival time. The NMO correction is a function of the vertical reflection time for a specific horizon, the offset of for a specific source-sensor pair, and the velocity of the seismic wave in the subsurface formation. The vertical reflection time for a specific horizon and the offset of for a specific source-sensor pair are known parameters for each trace. However, the velocity is usually not readily available. As previously discussed, the velocity of seismic waves depends properties such as, for example, density, porosity, and fluid content of the medium through which the seismic waves are traveling and consequently varies with location in the subsurface formation be studied.

FIG. 2C shows a stack trace 207 generated by summing the traces 205 of the CMP gather and dividing the resulting amplitudes by the number of traces in the gather. The number of traces in the gather is also referred to as the fold of the gather. The noise tends to cancel out and the reflections (R₁, R₂, R₃) from the horizons of the subsurface formation are enhanced.

In seismic exploration, first-break picking includes determining the onsets of the first signal arrivals at seismic receivers, given a set of seismic traces. In general, these arrivals are associated with the energy of refracted waves at the base of the weathering layer or the direct wave that travels directly from the source to the receiver. The first arrivals onset first-break times are used for calculating static corrections and estimating near-surface velocities for the subsurface formation. The effectiveness of reflection- and refraction-based methods of static corrections depends on the picking-process reliability. Applications such as near-surface tomographic static corrections require a precise and rapid automated detection of the signal first arrivals. First-break quality is related to the near-surface structure, source type, and signal-to-noise ratio conditions. Automated picking of first breaks can be difficult for data acquired in complex near-surface geologies or if the S/N is low. Moreover, if the source wavelet is zero-phase, as when Vibroseis sources are used, the sweep correlation can produce side-lobes that arrive before the first break increasing the difficulty of the first break picking process.

In a geologically complex subsurface formation, an inverted tomogram from a travel-time inversion can be used as a starting model for waveform inversion to recover highly-resolved velocity details of the subsurface formation. Full waveform inversion (FWI) has shown great potential for revealing high-resolution details of the subsurface medium. In some cases, only a fraction of the seismic data, such as the refraction or diving waves, is used as an input for acoustic waveform inversion because the misfit function of early arrivals has fewer local minima than that of the full data set and the acoustic approximation is more accurate for early arrivals. Therefore, improving early arrivals data for waveform inversion can improve the high-resolution near-surface velocities.

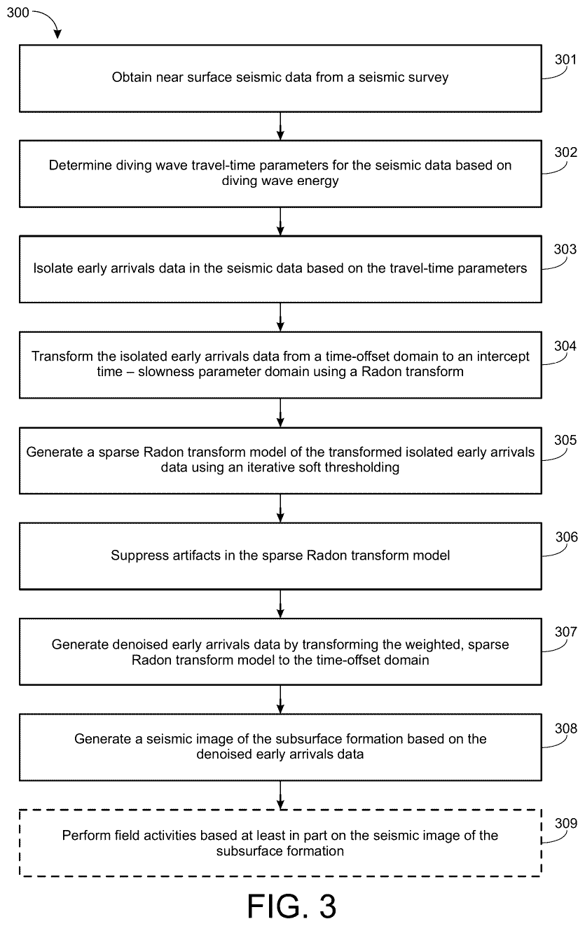

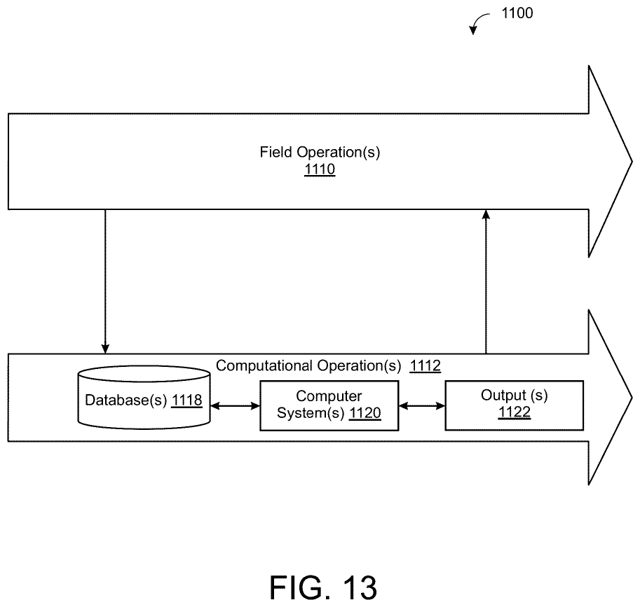

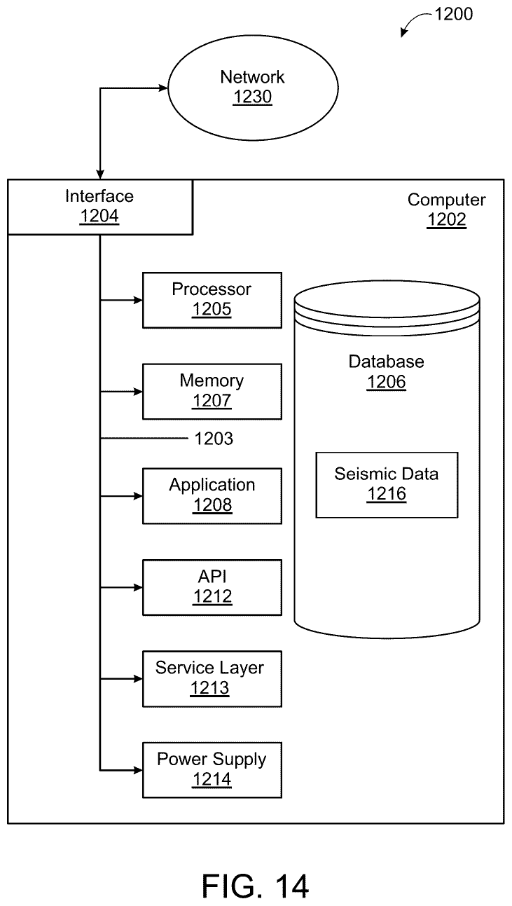

FIG. 3 is an example flow chart of a method 300 for improving the S/N ratio of the early arrivals in seismic data. The method 300 can be implemented on a data processing system such as a computer or control system (e.g., computer system 124 or the computer systems of FIG. 13 or 14). The method 300 includes a SEAI and a weighted, sparse Radon transform. The SEAI utilizes the offset-dimension information in the seismic data to obtain a reasonable processing zone, for example, by stacking the diving wave energy prior to first breaks picking. Diving waves are, for example, seismic waves that travel downward into the subsurface formation with velocities continuously increasing with depth causing the waves to eventually bend back towards the surface. The weighted, sparse Radon transform increases the signal-to-noise ratio and suppresses artifacts in the given range. Because the inverse Radon transform operator is not the true inverse operator, but a conjugate operator, the method 300 includes building the τ-p domain signal in least-squares sense, where r is the intercept time, and p is the slowness parameter. The method 300 can further suppress noise through an iterative soft thresholding technique and by applying a weighting function in the τ-p domain.

The data processing system obtains near surface seismic data from a seismic survey (step 301). The seismic data represents a subsurface formation. The data processing system can obtain the seismic data, for example, by conducting a seismic survey of the subsurface formation (e.g., the seismic survey of FIG. 1). In some implementations, the data processing system obtains the seismic data by accessing one or more hardware storage devices where data from a previously conducted seismic survey have been stored.

SEAI utilizes the offset-dimension information in the seismic data to obtain a reasonable picking zone. The data processing system determines diving wave travel-time parameters for the seismic data based on diving wave energy (step 302). The observed early arrivals in one seismic gather are assumed to be associated with one 1D velocity model that is linearly increasing with depth as v=kz+v₀, where v₀ is the surface velocity and k is the velocity slope. The travel-time equation of the diving wave in such a linear model is expressed as

$$t ( x ) = \frac{2}{k} log ( \frac{k x}{2 {v}_{0}} + \sqrt{1 + \frac{{k}^{2} {x}^{2}}{4 {v}_{0}^{2}}} ) . \qquad ( 1 )$$

The data processing system can scan the parameters of v₀ and k, stack normalized diving wave energy from the seismic data along the computed travel-time, and then choose the parameters (v₀′, k′) that correspond to the strongest stacked energy.

The data processing system isolates the early arrivals data in the seismic data based on the travel-time parameters (step 303). For example, the data processing system determines the travel-times corresponding to the optimal parameters (v₀′, k′). The data processing system then uses the determined travel-times as a guide to isolate the processing zone using a predefined window length, where the window length is a time. In some cases, the travel-time determined from the parameters (v₀′, k′) may pass through the shallow refraction energy following the early arrivals as opposed to the true early arrivals. This may not adversely affect the final selection quality of the isolated processing zone because the determined travel-times are used only to define a window to restrict the processing zone to a smaller area and not to a precise location. In addition, during the scanning process the surface wave and reflected events can be avoided by limiting the range of v₀ and k that the data processing system scans because the surface wave and reflected events have quite different apparent velocities or curvatures compared with the early arrivals.

The data processing system can split the isolated early arrivals data into many overlapping windows. Splitting the data into multiple windows aids the approximate linearity of the denoised data following the Radon transform. An example value for the window length nwx is 1 km and the overlapping percent can range from 5%-50%. In some implementations, the overlapping percent is specified as 20%. In an example, if the spatial sampling is 10 m, the window length nwx is 1000 m, and the overlapping percent is 20%, which covers 20 samples in the offset direction.

The data processing system transforms the isolated early arrivals data from a time-offset domain to the intercept time-slowness parameter domain (τ-p domain) using a Radon transform (step 304). In implementations using multiple windows, the data processing system transforms the isolated early arrivals for each window separately and merges the results from all windows after transformation back to the time-offset domain.

A standard Radon transform is formulated as,

$$u ( τ , p ) = {\sum }_{j = 1}^{N} d ( t = τ + p {x}_{j} , {x}_{j} ) , \qquad ( 2 )$$

where τ and p stand for the intercept time and the slowness parameter, respectively, d(t, x) is one shot gather or receiver gather, and t and x represent the time and offset index for the input gather, respectively. The inverse Radon transform is formulated as,

$$d ( t , x ) = {\sum }_{j = 1}^{N} u ( τ = t - {p}_{j} x , {p}_{j} ) + e ( t , x ) , \qquad ( 3 )$$

where e(t, x) represents random noise, blended signals and unmodeled scattered waveforms. However, the inverse Radon transform operator is not the true inverse operator but a conjugate operator. To construct the true inverse operator, the data processing system builds the τ-p domain signal in a least-squares sense.

The data processing system generates a sparse Radon transform model of the early arrivals data using an iterative soft thresholding (step 305). The data processing system builds the sparse Radon transform so that the result by the inverse transform can match the input data (e.g., early arrivals). The sparse Radon transform can be formulated as,

$$min {‖ Lm - d ‖}_{2}^{2} + μ {‖ m ‖}_{1} , \qquad ( 4 )$$

where L is the inverse Radon operator, d is the input data, m is the result after the Radon transform, and y is a regularization parameter. The data processing system applies an iterative soft thresholding (IST) method to solve the optimization problem defined in equation 4. The optimization leads to an L1-norm minimization of the model. In this step, the data processing system attempts to estimate the sparse level of the solution and provide a good initial estimate for the next stage. The IST method generates a new point as

mₖ₊₁=T_{aμ}(mₖ+αL^{T}(Lmₖ−d)) (5)

Because L denotes the inverse Radon operator that maps the Radon transform domain to the time-offset domain, L^{T} is the forward Radon transform. Here, a is the step length and Tag is the shrinkage threshold operator.

T_{αμ}=sign(m)⊙ max{|m|−αμ,0}, (6)

where sign(m) is 1, 0, or −1 according to the sign of the component. The symbol ⊙ denotes the component-wise product of two vectors. Intuitively, at each iteration (equation 5), mₖ+αL^{T}(Lmₖ−d) resembles a gradient descent step for the L2-norm term in the objective function; and the effect of the operator T_{αμ} is to reduce the magnitude of each nonzero component of m by ap and vanish negative results, thereby reducing the L1-norm of the model m. This shrinkage thresholding iteration (equation 5) is an extension of the steepest-descent method. One appealing feature is that the shrinkage-thresholding iteration (equation 5) yields the optimal solution of the L1-norm regularized minimization problem (equation 4) in a finite number of iterations under suitable conditions.

Once the data processing system obtains an approximate solution m of the L1-norm regularized minimization problem (equation 4), the data processing system can transform the signals back to the time-offset domain (t-x domain). During the inverse transform, the data processing system can further improve the results by filtering the data to exclude undesired signals by defining a slowness interval Δpⱼ before transforming the data back to the spatial domain. Filtering the data in this manner can remove artifacts with different slowness from the early arrivals data.

The data processing system suppresses artifacts in the sparse Radon transform model by applying a weight in the τ-p domain. For example, the below equation in the τ-p domain acts as a weight to further enhance the coherent signal and depress the noise,

$$s ( τ , p ) = \frac{{\sum }_{l = - L / 2}^{L / 2} {[ {\sum }_{k = 1}^{N} d ( t = τ + p {x}_{k} + l Δl , {x}_{k} ) ]}^{2}}{N {\sum }_{l = - L / 2}^{L / 2} {\sum }_{k = 1}^{N} {d}^{2} ( t = τ + p {x}_{k} + l Δ l , {x}_{k} )} , \qquad ( 7 )$$

where the time-window width L is typically chosen to cover between one sample to over a few periods of the signal noting that a large window can increase the stability. However, a larger window can decrease the weight resolution. N stands for the window width in space. The extent of N can be broad to cover enough traces for stacking, but not over a range where a linear approximation of the events cannot be justified. The default value for L is one period of the early arrivals.

The data processing system generates denoised early arrivals data by transforming the weighted, sparse Radon transform model to the t-x domain (step 307). For example, the data processing system applies the inverse transform using the equation below:

$${d}^{′} ( t , x ) = {\sum }_{j = 1}^{N} u ( τ , {p}_{j} ) s ( τ , {p}_{j} ) Δ {p}_{j} , \qquad ( 8 )$$

where Δpⱼ is the slowness interval. The difference between the original data d(t, x) and the denoised data d′(t, x) includes the data not modeled by the Radon transform, which is mostly random noises, events with less-coherence measurements, which are attenuated by the weights, and events with undesired moveouts, which are muted through constraints of the angle range in the Radon domain. The term u(τ,pⱼ) corresponds to the m from the last iteration of the iterative soft thresholding process.

The data processing system generates a seismic image of the subsurface formation based on the denoised early arrivals data (step 308). In some implementations, the data processing system performs field activities based at least in part on the seismic image of the subsurface formation (step 309). For example, in some implementations, the data processing system controls drilling equipment to drill one or more new wells at locations in the subsurface formation identified at least in part based on the seismic image. For example, the data processing system can generate control commands for the drilling equipment (on-site or remotely) based on the seismic image to drill the wells at the identified locations. The seismic image can indicate, for example, sedimentary facies or other geological features in the subsurface that can be used to determine drilling parameters (e.g., drilling speed, rate of penetration, etc.).

In some implementations, seismic traces with strong amplitude anomalies or noise bursts from can affect the results of the SEAI. In such implementations, the data processing system can remove the noise bursts or strong amplitude anomalies from the input data prior to isolating the early arrivals data.

Numerical tests were performed on several seismic datasets to demonstrate that the method 300 can reasonably isolate the picking zone of first breaks, improve the S/N of the early arrivals by enhancing the coherent signal and suppressing random noise, and attenuate interference caused by undesired coherent events.

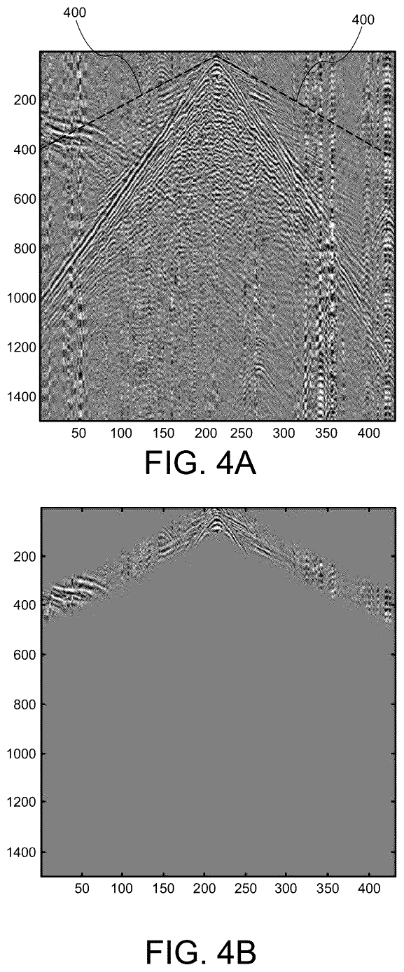

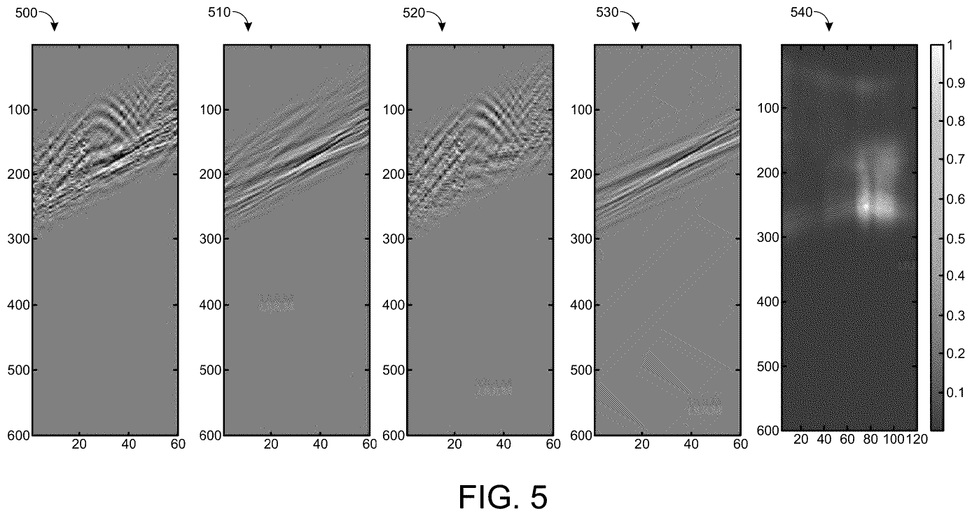

FIGS. 4A, 4B, and 5 show data and results from one receiver line from a 3D common-shot gather. FIG. 4A shows the raw data with blended signals, strong noise and ground rolls which can jeopardize the picking accuracy and the subsequent near-surface velocities estimation. The SEAI technique from the method 300 was applied to the raw data to obtain the guide 400 to isolate the early arrivals data in the processing zone using a reasonable range of velocity gradient and surface velocity. FIG. 4B shows the isolated early arrivals data.

FIG. 5 shows intermediate and final results of applying the method 300 to a window of data from the isolated early arrivals data shown in FIG. 4B. The isolated early arrivals data was split into many windows with sufficient overlapping. Image 500 shows the windowed isolated early arrivals data. Image 510 shows the sparse Radon transform result (without weighting). The sparse Radon transform demonstrates that the deblended signals are well suppressed and the S/N is also boosted. Image 520 shows the difference between images 500 and 510 demonstrating the noise removed from the raw data and the resulting improvement. In image 510 most of the undesired artifacts and noise are removed. To further improve the coherency and highlight the signals, a weight was applied to the sparse Radon transformed data during inverse transformation. Image 530 shows the denoised data after conversion from the τ-p domain to the t-x domain after applying the weight. Compared with image 510, the denoised data in image 530 is further enhanced and some events ahead of the first breaks in image 510 have ben removed. Plot 540 shows the computed semblance weight in the τ-p domain applied to denoise the data in image 530.

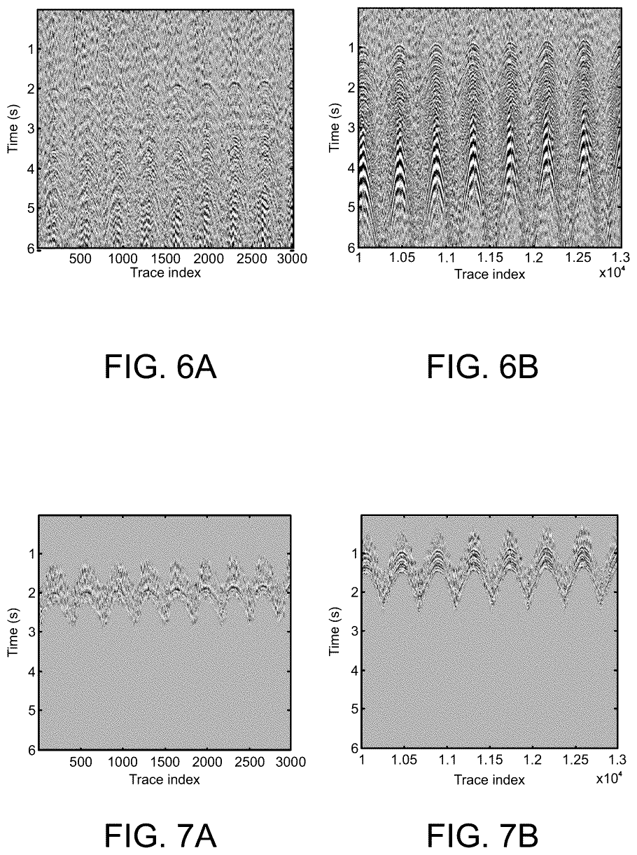

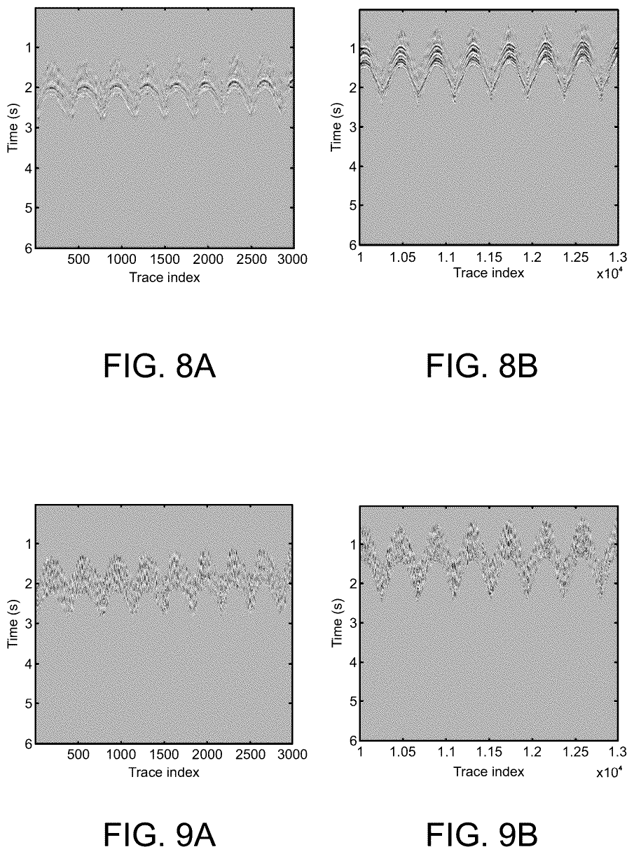

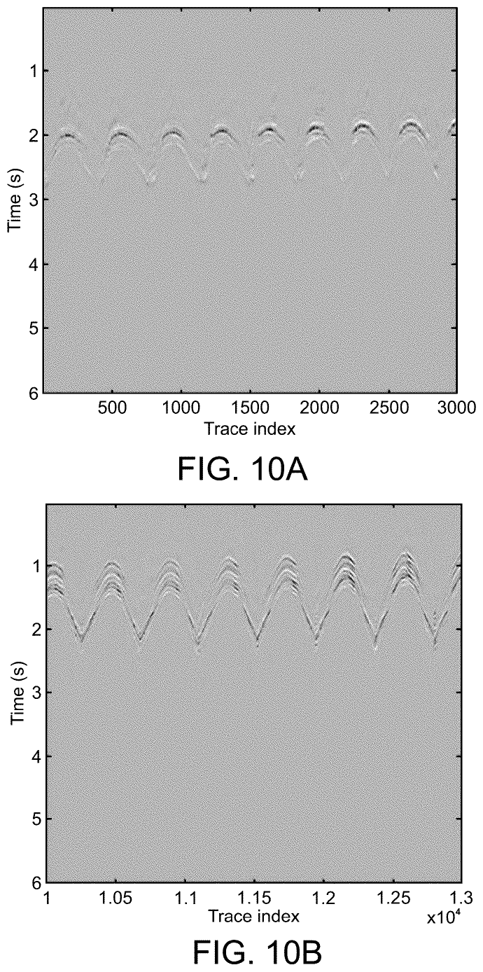

FIGS. 6A-10B show processed data from another 3D shot gather using the method 300. Two parts of the raw seismic data are shown in FIGS. 6A and 6B. The first breaks are difficult to identify at large offsets due to strong noise contamination. FIGS. 7A and 7B show the automatically isolated early arrivals data demonstrating that the early arrivals are reasonably separated. FIGS. 8A and 8B show the denoised data from the sparse Radon transform (without applying weighting) demonstrating suppressed noise. FIGS. 9A and 9B demonstrate the noise removed from the raw data as the difference between the input isolated early arrivals (FIGS. 7A and 7B) and the denoised data from the sparse Radon transform (FIGS. 8A and 8B). Only noise has been removed, with no coherent signals present in FIGS. 9A and 9B. FIGS. 10A and 10B show further enhanced coherency and highlighted first breaks after applying the weighted sparse Radon transform. A comparison between FIGS. 8A and 8B and FIGS. 10A and 10B demonstrates that the background noise is further suppressed, making the first breaks easier to identify. The processing of the data for FIGS. 6A-10B included a windowing strategy as described above. A typically spatial window length is 750 meters with a 20% to 40% overlapping zone. After processing all of the windowed data, the windowed data is merged into the whole dataset by assigning appropriate weights in the overlapping zones. For a specific trace, the sum of the weights from all contributing windows should equal 1.

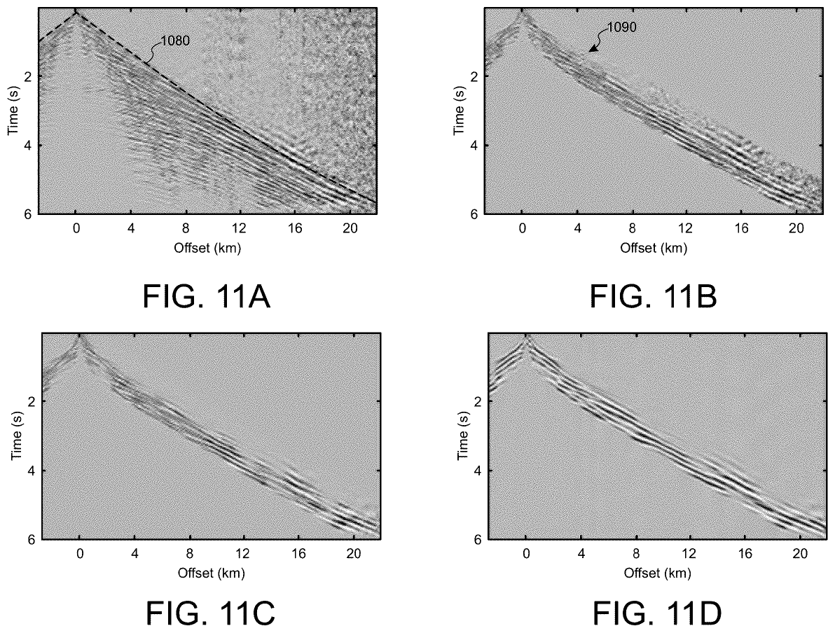

FIGS. 11A-11D show an example of stages of seismic data processing to enhance the S/N ratio. FIG. 11A shows the preprocessed seismic data after surface-consistent scaling and FK filtering. The guide 1080 for determining the window for isolating the early arrivals is shown as a dashed line. FIG. 11B shows isolated early arrivals in the seismic data isolated using the SEAI process described above. The early arrivals still include hyperbolic artifacts 1090 and background noise. FIG. 11C shows data after applying an implementation of the method 300. The hyperbolic artifacts and background noise are well suppressed, while coherent signals are enhanced. Furthermore, to reduce a likelihood that a FWI converges to a local minimum, the enhanced early arrivals were further filtered to exclude frequencies above 10 Hz. FIG. 11 D shows the high-quality low-frequency components obtained after filtering. The filtered data can then be used to generate a tomogram representing the subsurface formation.

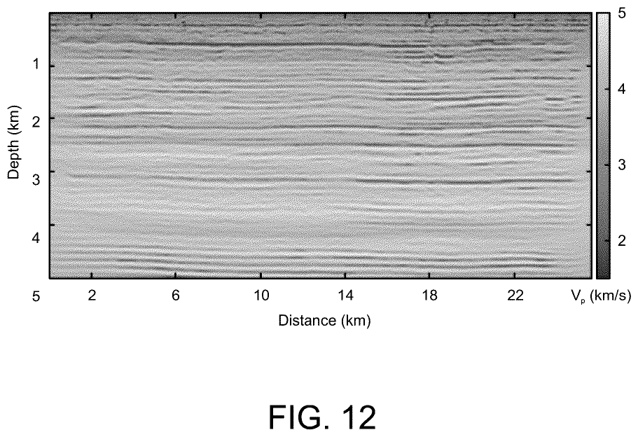

FIG. 12 is an example tomogram that overlays a FWI model over an associated seismic image. The tomogram demonstrates that a FWI performed on data with enhanced S/N ratio can provide a detailed near-surface velocity update revealing complex geologic features that align with its associated seismic image.

FIG. 13 illustrates hydrocarbon production operations 1100 that include both one or more field operations 1110 and one or more computational operations 1112, which exchange information and control exploration for the production of hydrocarbons. In some implementations, outputs of techniques of the present disclosure (e.g., the method 500) can be performed before, during, or in combination with the hydrocarbon production operations 1100, specifically, for example, either as field operations 1110 or computational operations 1112, or both.

Examples of field operations 1110 include forming/drilling a wellbore, hydraulic fracturing, producing through the wellbore, injecting fluids (such as water) through the wellbore, to name a few. In some implementations, methods of the present disclosure can trigger or control the field operations 1110. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 1110 and responsively triggering the field operations 1110 including, for example, generating plans and signals that provide feedback to and control physical components of the field operations 1110. Alternatively, or in addition, the field operations 1110 can trigger the methods of the present disclosure. For example, implementing physical components (including, for example, hardware, such as sensors) deployed in the field operations 1110 can generate plans and signals that can be provided as input or feedback (or both) to the methods of the present disclosure.

Examples of computational operations 1112 include one or more computer systems 1120 that include one or more processors and computer-readable media (e.g., non-transitory computer-readable media) operatively coupled to the one or more processors to execute computer operations to perform the methods of the present disclosure. The computational operations 1112 can be implemented using one or more databases 1118, which store data received from the field operations 1110 and/or generated internally within the computational operations 1112 (e.g., by implementing the methods of the present disclosure) or both. For example, the one or more computer systems 1120 process inputs from the field operations 1110 to assess conditions in the physical world, the outputs of which are stored in the databases 1118. For example, seismic sensors of the field operations 1110 can be used to perform a seismic survey to map subsurface features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 1112 where they are stored in the databases 1118 and analyzed by the one or more computer systems 1120.

In some implementations, one or more outputs 1122 generated by the one or more computer systems 1120 can be provided as feedback/input to the field operations 1110 (either as direct input or stored in the databases 1118). The field operations 1110 can use the feedback/input to control physical components used to perform the field operations 1110 in the real world.

For example, the computational operations 1112 can process the seismic data to generate three-dimensional (3D) maps of the subsurface formation. The computational operations 1112 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 1112 to process new information about the formation and control the drilling to adjust to the observed conditions in real-time.

The one or more computer systems 1120 can update the 3D maps of the subsurface formation as information from one exploration well is received and the computational operations 1112 can adjust the location of the next exploration well based on the updated 3D maps. Similarly, the data received from production operations can be used by the computational operations 1112 to control components of the production operations. For example, production well and pipeline data can be analyzed to predict slugging in pipelines leading to a refinery and the computational operations 1112 can control machine operated valves upstream of the refinery to reduce the likelihood of plant disruptions that run the risk of taking the plant offline.

In some implementations of the computational operations 1112, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second (s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart or are located in different countries or other jurisdictions.

FIG. 14 is a block diagram of an example computer system 1200 used to provide computational functionalities associated with described algorithms, methods, functions, processes, flows, and procedures described in the present disclosure, according to some implementations of the present disclosure. The illustrated computer 1202 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 1202 can include input devices such as keypads, keyboards, and touch screens that can accept user information. Also, the computer 1202 can include output devices that can convey information associated with the operation of the computer 1202. The information can include digital data, visual data, audio information, or a combination of information. The information can be presented in a graphical user interface (UI) (or GUI).

The computer 1202 can serve in a role as a client, a network component, a server, a database, a persistency, or components of a computer system for performing the subject matter described in the present disclosure. The illustrated computer 1202 is communicably coupled with a network 1230. In some implementations, one or more components of the computer 1202 can be configured to operate within different environments, including cloud-computing-based environments, local environments, global environments, and combinations of environments.

At a high level, the computer 1202 is an electronic computing device operable to receive, transmit, process, store, and manage data and information associated with the described subject matter. According to some implementations, the computer 1202 can also include, or be communicably coupled with, an application server, an email server, a web server, a caching server, a streaming data server, or a combination of servers.

The computer 1202 can receive requests over network 1230 from a client application (for example, executing on another computer 1202). The computer 1202 can respond to the received requests by processing the received requests using software applications. Requests can also be sent to the computer 1202 from internal users (for example, from a command console), external (or third) parties, automated applications, entities, individuals, systems, and computers.

Each of the components of the computer 1202 can communicate using a system bus 1203. In some implementations, any or all of the components of the computer 1202, including hardware or software components, can interface with each other or the interface 1204 (or a combination of both), over the system bus 1203. Interfaces can use an application programming interface (API) 1212, a service layer 1213, or a combination of the API 1212 and service layer 1213. The API 1212 can include specifications for routines, data structures, and object classes. The API 1212 can be either computer-language independent or dependent. The API 1212 can refer to a complete interface, a single function, or a set of APIs.

The service layer 1213 can provide software services to the computer 1202 and other components (whether illustrated or not) that are communicably coupled to the computer 1202. The functionality of the computer 1202 can be accessible for all service consumers using this service layer. Software services, such as those provided by the service layer 1213, can provide reusable, defined functionalities through a defined interface. For example, the interface can be software written in JAVA, C++, or a language providing data in extensible markup language (XML) format. While illustrated as an integrated component of the computer 1202, in alternative implementations, the API 1212 or the service layer 1213 can be stand-alone components in relation to other components of the computer 1202 and other components communicably coupled to the computer 1202. Moreover, any or all parts of the API 1212 or the service layer 1213 can be implemented as child or sub-modules of another software module, enterprise application, or hardware module without departing from the scope of the present disclosure.

The computer 1202 includes an interface 1204. Although illustrated as a single interface 1204 in FIG. 14, two or more interfaces 1204 can be used according to particular needs, desires, or particular implementations of the computer 1202 and the described functionality. The interface 1204 can be used by the computer 1202 for communicating with other systems that are connected to the network 1230 (whether illustrated or not) in a distributed environment. Generally, the interface 1204 can include, or be implemented using, logic encoded in software or hardware (or a combination of software and hardware) operable to communicate with the network 1230. More specifically, the interface 1204 can include software supporting one or more communication protocols associated with communications. As such, the network 1230 or the interface's hardware can be operable to communicate physical signals within and outside of the illustrated computer 1202.

The computer 1202 includes a processor 1205. Although illustrated as a single processor 1205 in FIG. 14, two or more processors 1205 can be used according to particular needs, desires, or particular implementations of the computer 1202 and the described functionality. Generally, the processor 1205 can execute instructions and can manipulate data to perform the operations of the computer 1202, including operations using algorithms, methods, functions, processes, flows, and procedures as described in the present disclosure.

The computer 1202 also includes a database 1206 that can hold data for the computer 1202 and other components connected to the network 1230 (whether illustrated or not). For example, database 1206 can hold data 1216 (e.g., resistivity data). For example, database 1206 can be an in-memory, conventional, or a database storing data consistent with the present disclosure. In some implementations, database 1206 can be a combination of two or more different database types (for example, hybrid in-memory and conventional databases) according to particular needs, desires, or particular implementations of the computer 1202 and the described functionality. Although illustrated as a single database 1206 in FIG. 14, two or more databases (of the same, different, or combination of types) can be used according to particular needs, desires, or particular implementations of the computer 1202 and the described functionality. While database 1206 is illustrated as an internal component of the computer 1202, in alternative implementations, database 1206 can be external to the computer 1202.

The computer 1202 also includes a memory 1207 that can hold data for the computer 1202 or a combination of components connected to the network 1230 (whether illustrated or not). Memory 1207 can store any data consistent with the present disclosure. In some implementations, memory 1207 can be a combination of two or more different types of memory (for example, a combination of semiconductor and magnetic storage) according to particular needs, desires, or particular implementations of the computer 1202 and the described functionality. Although illustrated as a single memory 1207 in FIG. 14, two or more memories 1207 (of the same, different, or combination of types) can be used according to particular needs, desires, or particular implementations of the computer 1202 and the described functionality. While memory 1207 is illustrated as an internal component of the computer 1202, in alternative implementations, memory 1207 can be external to the computer 1202.

The application 1208 can be an algorithmic software engine providing functionality according to particular needs, desires, or particular implementations of the computer 1202 and the described functionality. For example, application 1208 can serve as one or more components, modules, or applications. Further, although illustrated as a single application 1208, the application 1208 can be implemented as multiple applications 1208 on the computer 1202. In addition, although illustrated as internal to the computer 1202, in alternative implementations, the application 1208 can be external to the computer 1202.

The computer 1202 can also include a power supply 1214. The power supply 1214 can include a rechargeable or non-rechargeable battery that can be configured to be either user- or non-user-replaceable. In some implementations, the power supply 1214 can include power-conversion and management circuits, including recharging, standby, and power management functionalities. In some implementations, the power-supply 1214 can include a power plug to allow the computer 1202 to be plugged into a wall socket or a power source to, for example, power the computer 1202 or recharge a rechargeable battery.

There can be any number of computers 1202 associated with, or external to, a computer system containing computer 1202, with each computer 1202 communicating over network 1230. Further, the terms “client,” “user,” and other appropriate terminology can be used interchangeably, as appropriate, without departing from the scope of the present disclosure. Moreover, the present disclosure contemplates that many users can use one computer 1202 and one user can use multiple computers 1202.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, or IOS.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

A number of implementations of these systems and methods have been described. Nevertheless, it will be understood that various modifications may be made without departing from the spirit and scope of this disclosure. Accordingly, other implementations are within the scope of the following claims.

### EXAMPLES

In an example implementation, a method for enhancing a signal-to-noise ratio in a near surface seismic survey of a subsurface formation includes obtaining seismic data from a near surface seismic survey, the seismic data representing a subsurface formation; determining diving wave travel-time parameters for the seismic data based on diving wave energy; isolating early arrivals data in the seismic data based on the travel-time parameters, the early arrivals data representing first seismic waves to reach a seismic receiver after being generated by a seismic source; transforming the isolated early arrivals data from a time-offset domain to an intercept time-slowness parameter domain using a Radon transform; generating a sparse Radon transform model of the transformed isolated early arrivals data using an iterative soft thresholding technique; suppressing artifacts in the sparse Radon transform model by applying a weight to the sparse Radon transform model in the intercept time-slowness parameter domain; generating denoised early arrivals data by transforming the weighted, sparse Radon transform model to the time-offset domain using an inverse Radon transform; and generating a seismic image of the subsurface formation based on the denoised early arrivals data.

An aspect combinable with the example implementation includes performing field activities based at least in part on the seismic image of the subsurface formation.

In another aspect combinable with one, some, or all of the previous aspects, the determining the diving wave travel-time parameters includes stacking diving wave energy; and determining travel-time parameters corresponding to a strongest stacked diving wave energy.

In another aspect combinable with one, some, or all of the previous aspects, the travel-time parameters includes a surface velocity and a velocity slope.

In another aspect combinable with one, some, or all of the previous aspects, generating denoised early arrivals data includes filtering the weighted, sparse Radon transform model to a specified slowness range to remove data artifacts with slowness outside the specified range.

In another aspect combinable with one, some, or all of the previous aspects, the iterative soft thresholding technique includes applying a shrinkage threshold operator to the sparse Radon transform model that sets values of the sparse Radon transform less than a specified threshold equal to zero.

In another aspect combinable with one, some, or all of the previous aspects, the generating a sparse Radon transform model includes using an L1-norm penalty to enforce sparseness in the sparse Radon transform model.

Another aspect combinable with one, some, or all of the previous aspects includes windowing the isolated early arrivals data into to improve linearity of the denoised data, separately performing the transforming the isolated early arrivals data, the generating the sparse Radon transform model, the suppressing artifacts, and the generating denoised early arrivals data for each window; and merging the generated denoised early arrivals data from each window to generate the seismic image.

In another example implementation, a system for enhancing a signal-to-noise ratio in a near surface seismic survey of a subsurface formation includes one or more processors; a hardware storage device; and a computer readable medium. The computer readable medium stores instructions that when executed cause the one or more processors to perform operations including obtaining seismic data from a near surface seismic survey, the seismic data representing a subsurface formation; determining diving wave travel-time parameters for the seismic data based on diving wave energy; isolating early arrivals data in the seismic data based on the travel-time parameters, the early arrivals data representing first seismic waves to reach a seismic receiver after being generated by a seismic source; transforming the isolated early arrivals data from a time-offset domain to an intercept time-slowness parameter domain using a Radon transform; generating a sparse Radon transform model of the transformed isolated early arrivals data using an iterative soft thresholding technique; suppressing artifacts in the sparse Radon transform model by applying a weight to the sparse Radon transform model in the intercept time-slowness parameter domain; generating denoised early arrivals data by transforming the weighted, sparse Radon transform model to the time-offset domain using an inverse Radon transform; and generating a seismic image of the subsurface formation based on the denoised early arrivals data.

An aspect combinable with the example implementation includes performing field activities based at least in part on the seismic image of the subsurface formation.

In another aspect combinable with one, some, or all of the previous aspects, the determining the diving wave travel-time parameters includes stacking diving wave energy; and determining travel-time parameters corresponding to a strongest stacked diving wave energy.

In another aspect combinable with one, some, or all of the previous aspects, the travel-time parameters includes a surface velocity and a velocity slope.

In another aspect combinable with one, some, or all of the previous aspects, generating denoised early arrivals data includes filtering the weighted, sparse Radon transform model to a specified slowness range to remove data artifacts with slowness outside the specified range.

In another aspect combinable with one, some, or all of the previous aspects, the iterative soft thresholding technique includes applying a shrinkage threshold operator to the sparse Radon transform model that sets values of the sparse Radon transform less than a specified threshold equal to zero.

In another aspect combinable with one, some, or all of the previous aspects, the generating a sparse Radon transform model includes using an L1-norm penalty to enforce sparseness in the sparse Radon transform model.

Another aspect combinable with one, some, or all of the previous aspects includes windowing the isolated early arrivals data into to improve linearity of the denoised data, separately performing the transforming the isolated early arrivals data, the generating the sparse Radon transform model, the suppressing artifacts, and the generating denoised early arrivals data for each window; and merging the generated denoised early arrivals data from each window to generate the seismic image.

In another example implementation, one or more non-transitory, machine-readable storage devices store instructions for enhancing a signal-to-noise ratio in a near surface seismic survey of a subsurface formation. The instructions are executable by one or more processors to cause performance of operations including obtaining seismic data from a near surface seismic survey, the seismic data representing a subsurface formation; determining diving wave travel-time parameters for the seismic data based on diving wave energy; isolating early arrivals data in the seismic data based on the travel-time parameters, the early arrivals data representing first seismic waves to reach a seismic receiver after being generated by a seismic source; transforming the isolated early arrivals data from a time-offset domain to an intercept time-slowness parameter domain using a Radon transform; generating a sparse Radon transform model of the transformed isolated early arrivals data using an iterative soft thresholding technique; suppressing artifacts in the sparse Radon transform model by applying a weight to the sparse Radon transform model in the intercept time-slowness parameter domain; generating denoised early arrivals data by transforming the weighted, sparse Radon transform model to the time-offset domain using an inverse Radon transform; and generating a seismic image of the subsurface formation based on the denoised early arrivals data.

An aspect combinable with the example implementation includes performing field activities based at least in part on the seismic image of the subsurface formation.

In another aspect combinable with one, some, or all of the previous aspects, the determining the diving wave travel-time parameters includes stacking diving wave energy; and determining travel-time parameters corresponding to a strongest stacked diving wave energy.

In another aspect combinable with one, some, or all of the previous aspects, the travel-time parameters includes a surface velocity and a velocity slope.

In another aspect combinable with one, some, or all of the previous aspects, generating denoised early arrivals data includes filtering the weighted, sparse Radon transform model to a specified slowness range to remove data artifacts with slowness outside the specified range.

In another aspect combinable with one, some, or all of the previous aspects, the iterative soft thresholding technique includes applying a shrinkage threshold operator to the sparse Radon transform model that sets values of the sparse Radon transform less than a specified threshold equal to zero.

In another aspect combinable with one, some, or all of the previous aspects, the generating a sparse Radon transform model includes using an L1-norm penalty to enforce sparseness in the sparse Radon transform model.

Another aspect combinable with one, some, or all of the previous aspects includes windowing the isolated early arrivals data into to improve linearity of the denoised data, separately performing the transforming the isolated early arrivals data, the generating the sparse Radon transform model, the suppressing artifacts, and the generating denoised early arrivals data for each window; and merging the generated denoised early arrivals data from each window to generate the seismic image.

What is claimed is:

1. A method for enhancing a signal-to-noise ratio in a near surface seismic survey of a subsurface formation, the method comprising:
obtaining seismic data from a near surface seismic survey, the seismic data representing a subsurface formation;
determining diving wave travel-time parameters for the seismic data based on diving wave energy;
isolating early arrivals data in the seismic data based on the travel-time parameters, the early arrivals data representing first seismic waves to reach a seismic receiver after being generated by a seismic source;
transforming the isolated early arrivals data from a time-offset domain to an intercept time-slowness parameter domain using a Radon transform;
generating a sparse Radon transform model of the transformed isolated early arrivals data using an iterative soft thresholding technique;
suppressing artifacts in the sparse Radon transform model by applying a weight to the sparse Radon transform model in the intercept time-slowness parameter domain;
generating denoised early arrivals data by transforming the weighted, sparse Radon transform model to the time-offset domain using an inverse Radon transform; and
generating a seismic image of the subsurface formation based on the denoised early arrivals data.

2. The method of claim 1, further comprising performing field activities based at least in part on the seismic image of the subsurface formation.

3. The method of claim 1, wherein the determining the diving wave travel-time parameters comprises: stacking diving wave energy; and determining travel-time parameters corresponding to a strongest stacked diving wave energy.

4. The method of claim 3, wherein the travel-time parameters comprise a surface velocity and a velocity slope.

5. The method of claim 1, wherein generating denoised early arrivals data comprises filtering the weighted, sparse Radon transform model to a specified slowness range to remove data artifacts with slowness outside the specified range.

6. The method of claim 1, wherein the iterative soft thresholding technique comprises applying a shrinkage threshold operator to the sparse Radon transform model that sets values of the sparse Radon transform less than a specified threshold equal to zero.

7. The method of claim 1, wherein the generating a sparse Radon transform model comprises using an L1-norm penalty to enforce sparseness in the sparse Radon transform model.

8. The method of claim 1, further comprising windowing the isolated early arrivals data into to improve linearity of the denoised data, separately performing the transforming the isolated early arrivals data, the generating the sparse Radon transform model, the suppressing artifacts, and the generating denoised early arrivals data for each window; and merging the generated denoised early arrivals data from each window to generate the seismic image.

9. A system for enhancing a signal-to-noise ratio in a near surface seismic survey of a subsurface formation, the system comprising:
one or more processors;
a hardware storage device; and
a computer readable medium storing instructions that when executed cause the one or more processors to perform operations comprising:
obtaining seismic data from a near surface seismic survey, the seismic data representing a subsurface formation;
determining diving wave travel-time parameters for the seismic data based on diving wave energy;
isolating early arrivals data in the seismic data based on the travel-time parameters, the early arrivals data representing first seismic waves to reach a seismic receiver after being generated by a seismic source;
transforming the isolated early arrivals data from a time-offset domain to an intercept time-slowness parameter domain using a Radon transform;
generating a sparse Radon transform model of the transformed isolated early arrivals data using an iterative soft thresholding technique;
suppressing artifacts in the sparse Radon transform model by applying a weight to the sparse Radon transform model in the intercept time-slowness parameter domain;
generating denoised early arrivals data by transforming the weighted, sparse Radon transform model to the time-offset domain using an inverse Radon transform; and
generating a seismic image of the subsurface formation based on the denoised early arrivals data.

10. The system of claim 9, further comprising performing field activities based at least in part on the seismic image of the subsurface formation.

11. The system of claim 9, wherein the determining the diving wave travel-time parameters comprises: stacking diving wave energy; and determining travel-time parameters corresponding to a strongest stacked diving wave energy.

12. The system of claim 11, wherein the travel-time parameters comprise a surface velocity and a velocity slope.

13. The system of claim 9, wherein generating denoised early arrivals data comprises filtering the weighted, sparse Radon transform model to a specified slowness range to remove data artifacts with slowness outside the specified range.

14. The system of claim 9, wherein the generating a sparse Radon transform model comprises using an L1-norm penalty to enforce sparseness in the sparse Radon transform model, and
wherein the iterative soft thresholding technique comprises applying a shrinkage threshold operator to the sparse Radon transform model that sets values of the sparse Radon transform less than a specified threshold equal to zero.

15. The system of claim 9, further comprising windowing the isolated early arrivals data into to improve linearity of the denoised data, separately performing the transforming the isolated early arrivals data, the generating the sparse Radon transform model, the suppressing artifacts, and the generating denoised early arrivals data for each window; and merging the generated denoised early arrivals data from each window to generate the seismic image.

16. One or more non-transitory, machine-readable storage devices storing instructions for enhancing a signal-to-noise ratio in a near surface seismic survey of a subsurface formation, the instructions being executable by one or more processors to cause performance of operations comprising:
obtaining seismic data from a near surface seismic survey, the seismic data representing a subsurface formation;
determining diving wave travel-time parameters for the seismic data based on diving wave energy;
isolating early arrivals data in the seismic data based on the travel-time parameters, the early arrivals data representing first seismic waves to reach a seismic receiver after being generated by a seismic source;
transforming the isolated early arrivals data from a time-offset domain to an intercept time-slowness parameter domain using a Radon transform;
generating a sparse Radon transform model of the transformed isolated early arrivals data using an iterative soft thresholding technique;
suppressing artifacts in the sparse Radon transform model by applying a weight to the sparse Radon transform model in the intercept time-slowness parameter domain;
generating denoised early arrivals data by transforming the weighted, sparse Radon transform model to the time-offset domain using an inverse Radon transform; and
generating a seismic image of the subsurface formation based on the denoised early arrivals data.

17. The one or more non-transitory, machine-readable storage devices of claim 16, wherein the determining the diving wave travel-time parameters comprises:
stacking diving wave energy; and
determining travel-time parameters corresponding to a strongest stacked diving wave energy,
wherein the travel-time parameters comprise a surface velocity and a velocity slope.

18. The one or more non-transitory, machine-readable storage devices of claim 16, wherein generating denoised early arrivals data comprises filtering the weighted, sparse Radon transform model to a specified slowness range to remove data artifacts with slowness outside the specified range.

19. The one or more non-transitory, machine-readable storage devices of claim 16, wherein the generating a sparse Radon transform model comprises using an L1-norm penalty to enforce sparseness in the sparse Radon transform model, and
wherein the iterative soft thresholding technique comprises applying a shrinkage threshold operator to the sparse Radon transform model that sets values of the sparse Radon transform less than a specified threshold equal to zero.

20. The one or more non-transitory, machine-readable storage devices of claim 16, further comprising windowing the isolated early arrivals data into to improve linearity of the denoised data, separately performing the transforming the isolated early arrivals data, the generating the sparse Radon transform model, the suppressing artifacts, and the generating denoised early arrivals data for each window; and merging the generated denoised early arrivals data from each window to generate the seismic image.
